(19) United States
(12) Patent Application Publication
(10) Pub. No.: US 2021/0297746 A1
(43) Pub. Date: Sep. 23, 2021

(54) REPRODUCTION DEVICE, REPRODUCING METHOD, AND PROGRAM

(71) Applicant: SONY CORPORATION, Tokyo (JP)

(72) Inventors: Mitsuru KATSUMATA, Tokyo (JP); Shihhao WEN, Tokyo (JP)

(73) Assignee: SONY CORPORATION, Tokyo (JP)

(21) Appl. No.: 16/330,541

(22) PCT Filed: Sep. 22, 2017
(86) PCT No.: PCT/JP2017/034237

§ 371 Date: Mar. 5, 2019

(30) Foreign Application Priority Data
Oct. 6, 2016 (JP) 2016-198249

(51) Int. Cl. H04N 21/472; G06F 3/0481; G06F 3/0484

(52) U.S. Cl. CPC H04N 21/47217; G06F 3/04847; G06F 3/0481

(57) ABSTRACT

There is provided a reproduction device, a reproducing method, and a program capable of providing a better user experience. A reproduction processing unit performs a process of reproducing a plurality of types of moving image contents in reproduction modes corresponding to the moving image contents, respectively. A user interface display processing unit performs a process of displaying a user interface displaying at least one of a type and a reproduction mode of the moving image content being reproduced. The present technology is applicable to, for example, a reproduction device capable of reproducing a 2D moving image content, a full spherical moving image content, and a free viewpoint moving image content.

### TECHNICAL FIELD

The present disclosure relates to a reproduction device, a reproducing method, and a program, and especially relates to a reproduction device, a reproducing method, and a program capable of providing a better user experience.

### BACKGROUND ART

Generally, moving image contents such as user-generated contents (UGC) are distributed in a distribution site that allows a user to upload a moving image, and moving image contents such as movies and dramas are distributed for free or for a fee in a commercial distribution site. Conventionally, as the moving image contents, a 2D moving image content in which a visual line direction and a viewpoint position are fixed by camera work at the time of content generation is a mainstream.

On the other hand, in recent years, it becomes possible to create a moving image content in which the visual line direction may be freely changed (hereinafter, referred to as a full spherical moving image content). In the full spherical sphere moving image content, the visual line direction may be changed according to an orientation of a face by using a head mounted display, for example, so that this has higher realistic feeling and is expected to become popular in the future.

Moreover, in the future, a moving image content in which the visual line direction may be changed as is the case with the full spherical moving image content and it is possible to move freely within a space reproduced by the moving image (hereinafter, referred to as a free viewpoint moving image content) is expected to become popular.

Meanwhile, as a user operation on the 2D moving image content, for example, when a moving image is provided using a video tape, basic reproduction, stopping, and the like are performed. Thereafter, for example, when the moving image is provided using a disk, since convenience of seeking is improved, a user interface such as a seek bar is newly proposed, and an operation of starting reproducing from a free reproducing time becomes possible.

Furthermore, conventionally, as a user interface for the full spherical moving image content, basically, the user interface used in the 2D moving image content is continuously used.

For example, Patent Document 1 discloses a 3D reproduction device capable of correctly displaying a 3D content in which a data part as the 2D content is edited.

### CITATION LIST

### Patent Document

Patent Document 1: Japanese Patent Application Laid-Open No. 2013-118538

### SUMMARY OF THE INVENTION

### Problems to be Solved by the Invention

Meanwhile, when the user interface used in the 2D moving image content is merely applied to the full spherical moving image content, the free viewpoint moving image content and the like, the user might feel inconvenient when using them. Therefore, a conventional situation is such that a sufficiently excellent user experience cannot be provided.

The present disclosure is achieved in view of such a situation and an object thereof is to provide a better user experience.

### Solutions to Problems

A reproduction device according to an aspect of the present disclosure is provided with a reproduction processing unit that performs a process of reproducing a plurality of types of moving image contents in reproduction modes corresponding to the moving image contents, respectively, and a display processing unit that performs a process of displaying a user interface displaying at least one of a type and a reproduction mode of a moving image content being reproduced.

A reproducing method or a program according to an aspect of the present disclosure includes steps of performing a process of reproducing a plurality of types of moving image contents in reproduction modes corresponding to the moving image contents, respectively, and performing a process of displaying a user interface displaying at least one of a type and a reproduction mode of a moving image content being reproduced.

In an aspect of the present disclosure, a process of reproducing a plurality of types of moving image contents in reproduction modes corresponding to the moving image contents, respectively, is performed, and a process of displaying a user interface displaying at least one of a type and a reproduction mode of a moving image content being reproduced is performed.

### Effects of the Invention

According to an aspect of the present disclosure, a better user experience may be provided.

### BRIEF DESCRIPTION OF DRAWINGS

FIG. 1 is a block diagram illustrating a configuration example of one embodiment of a reproduction device to which the present technology is applied.

FIG. 2 is a view illustrating an example of a user interface.

FIG. 3 is a view for explaining a reproduction icon.

FIG. 4 is a view for explaining a function of the reproduction icon.

FIG. 5 is a view for explaining a seek bar.

FIG. 6 is a view illustrating a variation of the reproduction icon.

FIG. 7 is a flowchart for explaining a displaying process of a user interface.

FIG. 8 is a block diagram illustrating a configuration example of one embodiment of a computer to which the present technology is applied.

### MODE FOR CARRYING OUT THE INVENTION

Hereinafter, a specific embodiment to which the present technology is applied is described in detail with reference to the drawings.

### Configuration Example of Reproduction Device

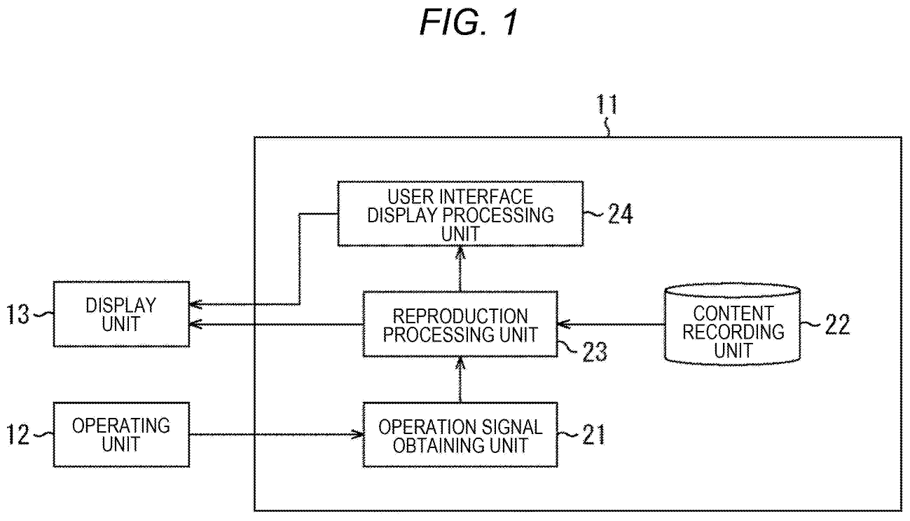

FIG. 1 is a block diagram illustrating a configuration example of one embodiment of a reproduction device to which the present technology is applied.

As illustrated in FIG. 1, a reproduction device 11 which may be used with an operating unit 12 and a display unit 13 connected is provided with an operation signal obtaining unit 21, a content recording unit 22, a reproduction processing unit 23, and a user interface display processing unit 24.

The operating unit 12 supplies various operation signals according to an operation by a user to the reproduction device 11, for example, by wire or by radio as a remote controller and the like. For example, the operating unit 12 may supply an operation signal for performing control regarding reproduction of a moving image content, an operation signal for performing control of a visual line direction or a viewpoint position as described later and the like to the reproduction device 11 according to the operation by the user.

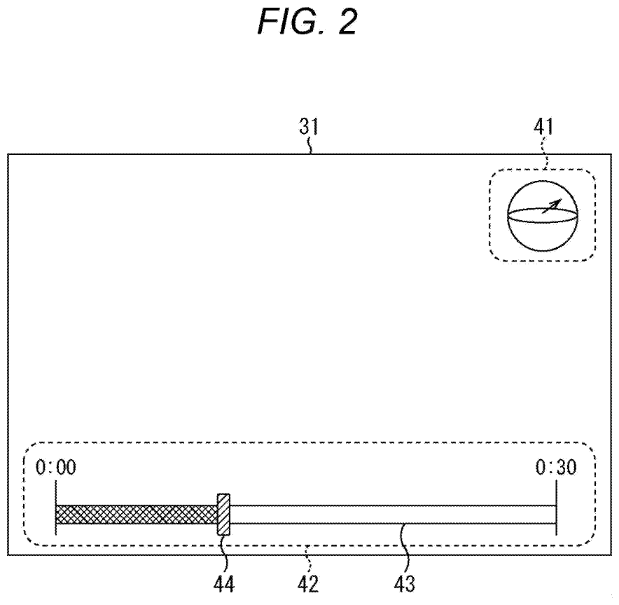

The display unit 13 displays the moving image content itself reproduced by the reproduction device 11 or displays various user interfaces as illustrated in FIG. 2 to be described later so as to be superimposed on the moving image content.

The operation signal obtaining unit 21 obtains the operation signal supplied from the operating unit 12 and supplies the same to the reproduction processing unit 23.

For example, a 2D moving image content, a full spherical moving image content, and a free viewpoint moving image content described above are recorded as the moving image content which may be reproduced by the reproduction device 11 in the content recording unit 22.

The reproduction processing unit 23 reads the moving image content from the content recording unit 22 to decode, performs a process of reproducing the moving image content, and supplies the moving image content to the display unit 13 to display.

For example, the reproduction processing unit 23 reads the 2D moving image content from the content recording unit 22 and reproduces the same in a 2D reproduction mode being a reproduction mode to view only in a specific visual line direction from a specific viewpoint position in which it is not possible to spatially move and look around. Furthermore, the reproduction processing unit 23 reads the full spherical moving image content from the content recording unit 22 and reproduces the same in a full spherical reproduction mode being a reproduction mode in which it is possible to look around in an arbitrary visual line direction from a specific viewpoint position though it is not possible to spatially move. Furthermore, the reproduction processing unit 23 reads the free viewpoint moving image content from the content recording unit 22 and reproduces the same in a free viewpoint reproduction mode being a reproduction mode in which it is possible to spatially move and look around in an arbitrary visual line direction from various viewpoint positions.

Furthermore, the reproduction processing unit 23 supplies information regarding the moving image content being reproduced (hereinafter referred to as “reproduced content information”) to the user interface display processing unit 24. For example, the reproduced content information includes information indicating the reproduction mode of the moving image content, information indicating the type of the moving image content, information indicating reproducing time of the moving image content and the like.

On the basis of the reproduced content information supplied from the reproduction processing unit 23, the user interface display processing unit 24 generates a user interface such as an icon presenting the type, the reproduction mode and the like of the moving image content being reproduced, a seek bar presenting the reproducing time of the moving image content being reproduced and the like, and supplies the same to the display unit 13 to display.

The reproduction device 11 configured in this manner may display the icon representing the type and the reproduction mode of the moving image content being reproduced, for example, and may provide a better user experience. In other words, with the icon displayed on the display unit 13 by the user interface display processing unit 24, the user may recognize which of the 2D moving image content, the full spherical moving image content, and the free viewpoint moving image content the moving image content being reproduced is. Similarly, the user may recognize which of the 2D reproduction mode, the full spherical reproduction mode, and the free viewpoint reproduction mode the reproduction mode of the moving image content being reproduced is.

Therefore, for example, the user may easily grasp whether or not it is possible to look around or to move in the moving image content being reproduced, so that the user may perform such operation smoothly and obtain a better user experience.

### Display Example of User Interface

FIG. 2 is a view illustrating an example of the user interface displayed on the display unit 13.

For example, the moving image content reproduced by the reproduction processing unit 23 is displayed on an entire reproduced screen 31 displayed on the display unit 13. Then, on the reproduced screen 31, as illustrated in FIG. 2, an icon display portion 41 is provided in an upper right corner of the reproduced screen 31 and a seek bar display portion 42 is provided on a lower side of the reproduced screen 31.

In the icon display portion 41, a reproduction mode icon representing the reproduction mode of the moving image content reproduced by the reproduction processing unit 23 is displayed. In the example in FIG. 2, a full spherical reproduction mode icon indicating that the reproduction processing unit 23 reproduces the moving image content in the full spherical reproduction mode is displayed. For example, the icon is displayed in the icon display portion 41 when an operation of instructing to display the user interface is performed.

In the seek bar display portion 42, a seek bar including a bar 43 representing a total reproduction time (0:30 in the example in FIG. 2) of the moving image content and a slider 44 representing a position corresponding to the reproducing time of a frame displayed on the reproduced screen 31 of the moving image content. For example, in the seek bar display portion 42, the seek bar is displayed when an operation of instructing to display the user interface, an operation of instructing fast forward or fast reverse and the like is performed.

### Display Example of Reproduction Icon

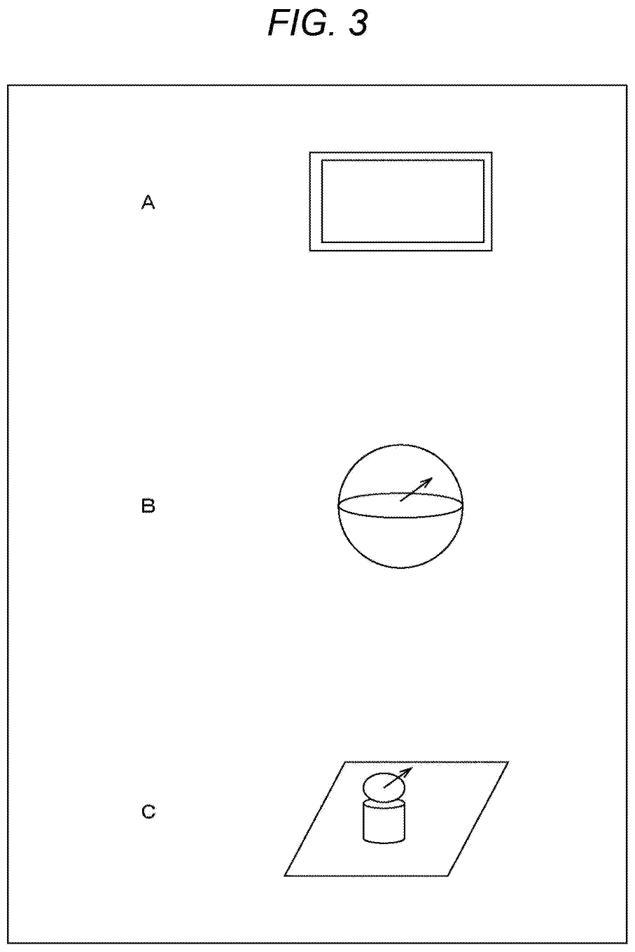

The reproduction icon displayed in the icon display portion 41 is described with reference to FIG. 3.

A of FIG. 3 illustrates an example of a 2D reproduction mode icon displayed in the icon display portion 41 of the reproduced screen 31 when the reproduction device 11 reproduces the moving image content in the 2D reproduction mode. For example, the 2D reproduction mode icon represents a characteristic of the 2D moving image content that the reproduced screen is a two-dimensional plane.

B of FIG. 3 illustrates an example of a full spherical reproduction mode icon displayed in the icon display portion 41 of the reproduced screen 31 when the reproduction device 11 reproduces the moving image content in the full spherical reproduction mode. For example, the full spherical reproduction mode icon represents a characteristic of the full spherical moving image content that the moving image in an arbitrary visual line direction is viewed by an outward arrow mark from the center of a spherical shape representing the full sphere reproduced by the moving image.

C of FIG. 3 illustrates a free viewpoint reproduction mode icon displayed in the icon display portion 41 of the reproduced screen 31 when the reproduction device 11 reproduces the moving image content in the free viewpoint reproduction mode. For example, the free viewpoint reproduction mode icon represents a characteristic of the free viewpoint moving image content that the moving image in an arbitrary viewpoint position and viewpoint direction is viewed by a human-shaped mark and an arrow mark arranged on a plane representing a movable range in a space reproduced by the moving image.

In this manner, the user interface display processing unit 24 may generate the reproduction icon representing the characteristic of the moving image content being reproduced, supply the same to the display unit 13, and display the same in the icon display portion 41 of the reproduced screen 31.

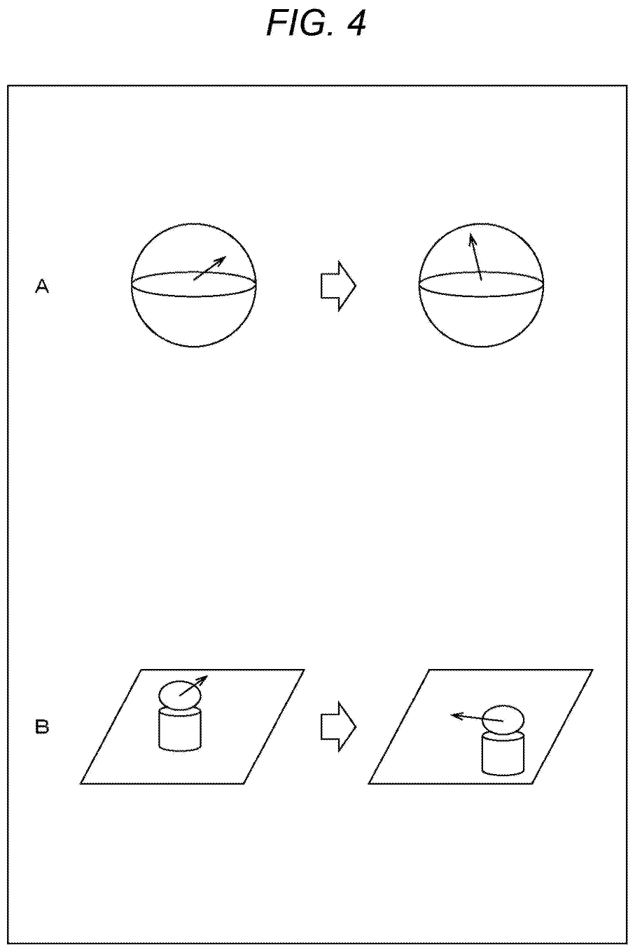

Functions of the full spherical reproduction mode icon and the free viewpoint reproduction mode icon are described with reference to FIG. 4.

For example, the full spherical reproduction mode icon (B of FIG. 3) includes the arrow mark, and the full spherical reproduction mode icon may have a function of representing the visual line direction by using this arrow mark.

A of FIG. 4 illustrates an example of the full spherical reproduction mode icon having a function of representing the visual line direction. The user interface display processing unit 24 changes a direction of the arrow mark displayed in the full spherical reproduction mode icon in accordance with the visual line direction of the user based on the operation signal obtained by the operation signal obtaining unit 21.

For example, suppose that the user performs an operation of facing upward at the time of the visual line direction of the full spherical reproduction mode icon as illustrated on a left side in A of FIG. 4. In synchronization with this operation, the user interface display processing unit 24 changes the direction of the arrow displayed in the full spherical reproduction mode icon so as to be in the visual line direction of the full spherical reproduction mode icon as illustrated on a right side in A of FIG. 4.

Furthermore, the free viewpoint reproduction mode icon (C of FIG. 3) includes the arrow mark and the human-shaped mark, and the full spherical reproduction mode icon may have a function of representing the visual line direction and the viewpoint position by using the arrow mark and the human-shaped mark.

In B of FIG. 4, an example of the free viewpoint reproduction mode icon having a function of representing the visual line direction and the viewpoint position is illustrated. The user interface display processing unit 24 changes the direction of the arrow mark and the position of the human-shaped mark displayed in the free viewpoint reproduction mode icon in accordance with an entire positional relationship of the free viewpoint moving image according to the visual line direction and the viewpoint position of the user based on the operation signal obtained by the operation signal obtaining unit 21.

For example, suppose that the user performs an operation of moving the viewpoint position to an end of the free viewpoint moving image and facing leftward when the viewpoint position is in the center of the free viewpoint moving image as in the free viewpoint reproduction mode icon illustrated on a left side in B of FIG. 4. In synchronization with this operation, the user interface display processing unit 24 changes the direction of the arrow and the position of the human-shaped mark displayed in the free viewpoint reproduction mode icon so as to be in the viewpoint position and the visual line direction of the free viewpoint reproduction mode icon as illustrated on a right side in B of FIG. 4.

In this manner, in the icon display portion 41, the full spherical reproduction mode icon may represent the visual line direction when the reproduction device 11 reproduces the moving image content in the full spherical reproduction mode. Similarly, in the icon display portion 41, the free viewpoint reproduction mode icon may represent the visual line direction and the viewpoint position when the reproduction device 11 reproduces the moving image content in the free viewpoint reproduction mode.

### Display Example of Seek Bar

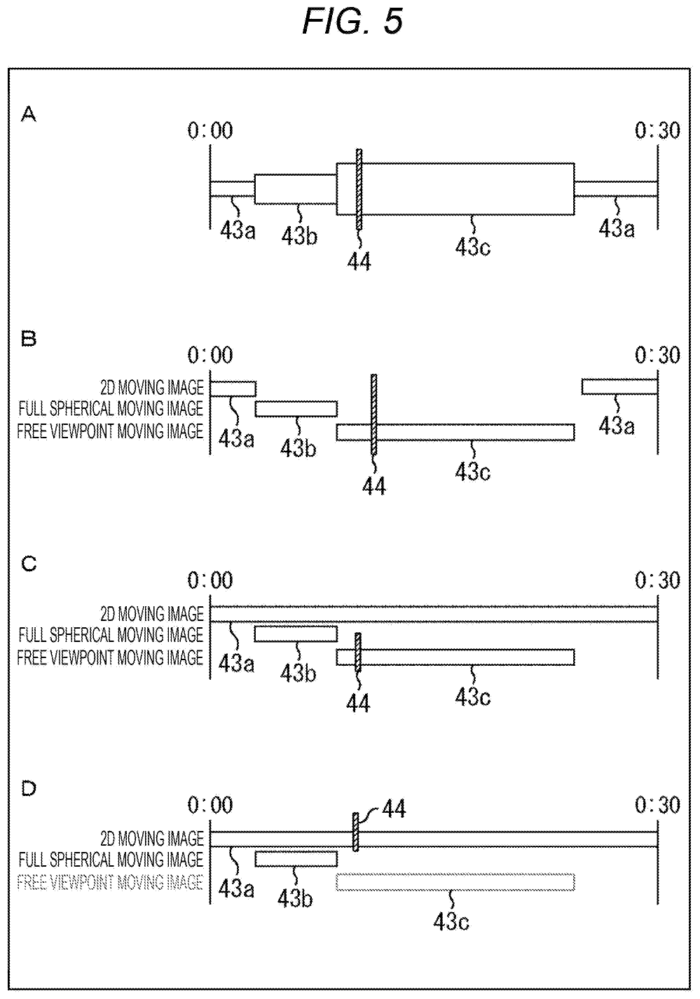

The seek bar displayed in the seek bar display portion 42 is described with reference to FIG. 5.

For example, the moving image content reproduced by the reproduction device 11 includes, in addition to that in which the 2D moving image content, the full spherical moving image content, and the free viewpoint moving image content are independently formed, that in which they are mixed for each reproduction time. Therefore, the seek bar displayed in the seek bar display portion 42 may have a function of distinguishing the reproduction times in the moving image content in which the 2D moving image content, the full spherical moving image content, and the free viewpoint moving image content are mixed.

A of FIG. 5 illustrates an example of the seek bar in which the reproduction times of the 2D moving image content, the full spherical moving image content, and the free viewpoint moving image content may be distinguished by a thickness of the bar 43. In the example in A of FIG. 5, a time during which the 2D moving image content may be reproduced is represented by a thinnest bar 43a, a time during which the full spherical moving image content may be reproduced is represented by an intermediate bar 43b, and a time during which the free viewpoint moving image content may be reproduced is represented by a thickest bar 43c.

B of FIG. 5 illustrates an example of the seek bar in which the reproduction times of the 2D moving image content, the full spherical moving image content, and the free viewpoint moving image content may be distinguished by an arrangement of the bar 43. In the example in B of FIG. 5, a time during which the 2D moving image content may be reproduced is represented by the bar 43a arranged in an upper stage, a time during which the full spherical moving image content may be reproduced is represented by the bar 43b arranged in an intermediate stage, and a time during which the free viewpoint moving image content may be reproduced is represented by the bar 43c arranged in a lower stage.

A method of distinguishing by the arrangement of the bar 43 (arrangement in parallel for each type of the moving image contents) in this manner may also be applied to a case where there is a plurality of types of moving image contents in the same reproduction time.

In other words, as illustrated in C of FIG. 5, the bar 43a arranged in an upper stage representing the time during which the 2D moving image content may be reproduced represents that the 2D moving image content may be reproduced from the beginning to the end of the time. Then, in parallel with the bar 43a, the bar 43b arranged in a middle stage and the bar 43c arranged in a lower stage are displayed, representing that either one of the moving image contents may be selectively reproduced during an overlapping time.

Furthermore, the seek bar illustrated in C of FIG. 5 may represent the moving image content reproduced out of a plurality of moving image contents which may be reproduced by an arrangement of the slider 44. In other words, in the example in C of FIG. 5, the slider 44 is arranged on the bar 43c representing the time during which the free viewpoint moving image content may be reproduced, representing that the free viewpoint moving image content is being reproduced.

Moreover, in this seek bar, for example, as is the case with the user interface capable of changing the reproduction time by performing an operation of moving the slider 44 rightward and leftward, it is possible to select the moving image content to be reproduced by performing an operation of moving the slider 44 upward and downward. It is possible to select the reproduction of the 2D moving image content or the free viewpoint moving image content by performing an operation of moving upward and downward the slider 44 in a display position in C of FIG. 5.

Note that, for example, in a case where the reproduction device 11 does not have the function of reproducing the free viewpoint moving image content, as illustrated in D of FIG. 5, it is possible to gray out the display of the bar 43c representing the time during which the free viewpoint moving image content may be reproduced. In other words, in the example illustrated in D of FIG. 5, it is illustrated that the reproduction device 11 has a function of reproducing the 2D moving image content and the full spherical moving image content. As a result, the function of the reproduction device 11 may be represented by the seek bar.

In this manner, the user interface display processing unit 24 may control the display of the seek bar, thereby distinguishing the reproduction times of the 2D moving image content, the full spherical moving image content, and the free viewpoint moving image content, and selecting the moving image content to be reproduced.

Note that, for example, also in a case where the moving image contents are not mixed, it is possible to similarly represent the types of the moving image contents by the thickness and arrangement of the bar 43. Furthermore, the types of the moving image contents may be represented by color, pattern and the like in addition to the thickness and arrangement of the bar 43.

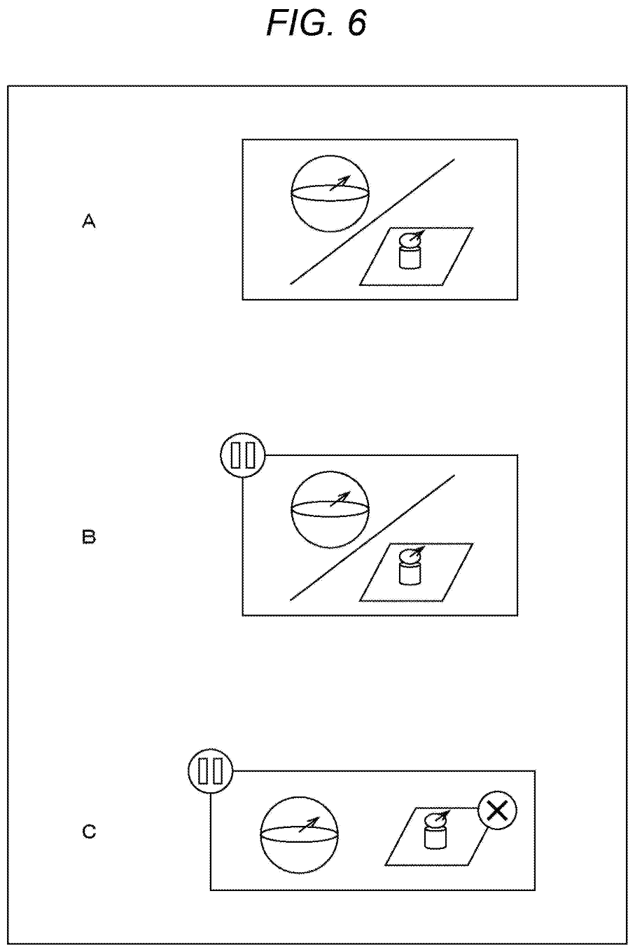

A variation of the reproduction icon is described with reference to FIG. 6.

A of FIG. 6 illustrates an example of the user interface that simultaneously displays the type and the reproduction mode of the moving image content using the reproduction icon.

For example, the reproduction processing unit 23 may reproduce the full spherical moving image content in the full spherical reproduction mode, and may reproduce the same in the 2D reproduction mode with the visual line direction and the viewpoint position fixed as is the case with the 2D moving image content. Similarly, the reproduction processing unit 23 may reproduce the free viewpoint moving image content in the free viewpoint reproduction mode, and reproduce the same in the 2D reproduction mode with the visual line direction and the viewpoint position fixed as is the case with the 2D moving image content and may reproduce the same in the full spherical reproduction mode with the viewpoint position fixed as is the case with the full spherical moving image content.

Therefore, it is possible to simultaneously display the icon representing the type of the moving image content and the icon representing the reproduction mode of the moving image content in the icon display portion 41 in FIG. 2 and allow the user to recognize the same.

For example, in the example in A of FIG. 6, the icon representing the reproduction mode of the moving image content is displayed in upper left and the icon representing the type of the moving image content is displayed in lower right. In other words, A of FIG. 6 illustrates that the free viewpoint moving image content is reproduced in the full spherical reproduction mode. Note that, such icon is displayed, for example, when an operation of instructing to display the user interface is performed.

B of FIG. 6 and C of FIG. 6 illustrate an example of the user interface representing a temporarily stopped state using the reproduction icon.

For example, in a case where an operation of temporarily stopping the free viewpoint moving image content in terms of time is performed, in addition to this, temporary stop of spatial movement and temporary stop of a viewing direction become possible. As a combination of them, three patterns are supposed: complete temporary stop (temporary stop in time, prohibition of movement, fixation of viewing direction), temporary stop of time and movement (only viewing direction may be changed), and temporary stop of only time (movement and change in viewing direction are possible).

Therefore, in B of FIG. 6, an example of the icon representing a temporarily stopped state in terms of time in which only the viewing direction may be changed is illustrated by displaying a temporary stop mark in upper left.

Furthermore, C of FIG. 6 illustrates an example of the icon which explicitly represents the operation which is temporarily stopped by displaying the icon representing the full spherical moving image content and the icon representing the free viewpoint moving image content side by side. In other words, the temporarily stopped state in terms of time is displayed by displaying the temporary stop mark in upper left, and it is displayed that the movement is also stopped with a cross mark on the icon representing the free viewpoint moving image content. With such user interface, the display in C of FIG. 6 is intuitively easier to understand than the display in B of FIG. 6.

Furthermore, the reproduction device 11 may have a function of making it possible to move, and a function of prohibiting to look around, for example, by selecting any icon in a state in which the icons illustrated in C of FIG. 6 are displayed.

Note that, for example, in a case where the reproduction device 11 does not have the function of reproducing the free viewpoint moving image content, it is possible to gray out the display of icon representing the free viewpoint moving image content.

### Reproducing Process of Moving Image Content

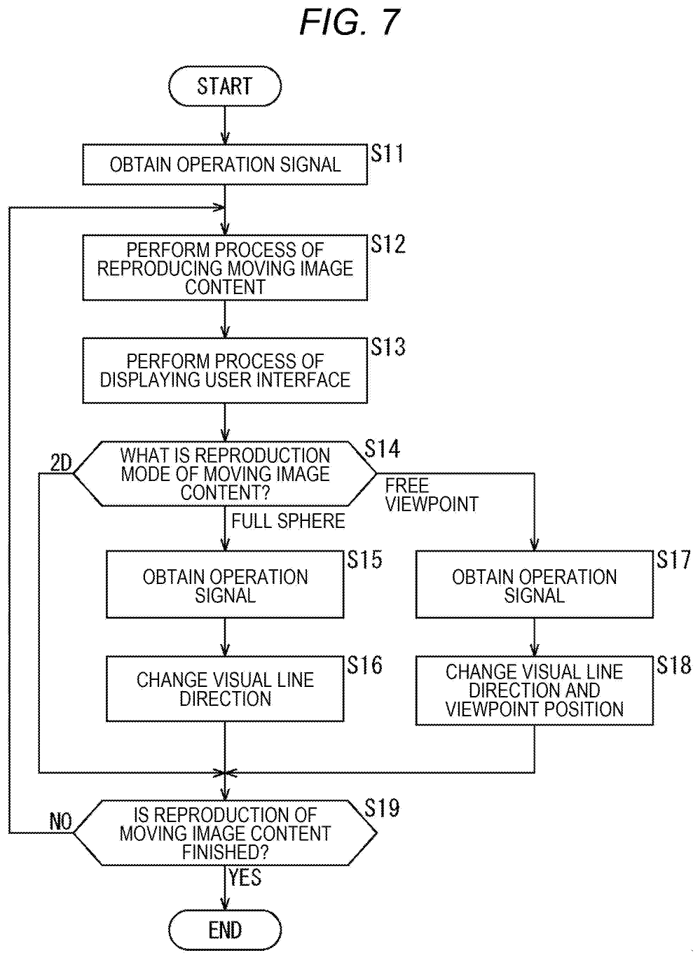

A reproducing process of the moving image content executed by the reproduction device 11 is described with reference to a flowchart in FIG. 7.

For example, when the user performs the operation on the operating unit 12 and an operation signal to select a predetermined moving image content as a reproduction target and instruct to reproduce by specifying the reproduction mode is supplied to the reproduction device 11, the reproducing process of the moving image content is started.

At step S11, the operation signal obtaining unit 21 obtains the operation signal supplied from the operating unit 12 and supplies the same to the reproduction processing unit 23.

At step S12, the reproduction processing unit 23 reads the moving image content which is made the reproduction target by the user from the content recording unit 22 according to the operation signal supplied from the operation signal obtaining unit 21 at step S11. Then, the reproduction processing unit 23 performs a process of reproducing the moving image content read from the content recording unit 22 in the reproduction mode specified by the operation signal supplied from the operation signal obtaining unit 21 at step S11, and displays the same on the display unit 13. Furthermore, the reproduction processing unit 23 supplies the reproduced content information regarding the moving image content reproduced at that time to the user interface display processing unit 24.

At step S13, the user interface display processing unit 24 performs a process of displaying the user interface on the display unit 13 on the basis of the reproduced content information supplied from the reproduction processing unit 23 at step S12. For example, the user interface display processing unit 24 displays the reproduction mode icon in the icon display portion 41 (FIG. 2) of the reproduced screen 31 according to the information indicating the reproduction mode of the moving image content included in the reproduced content information.

At step S14, the reproduction processing unit 23 determines which of the 2D reproduction mode, the full spherical reproduction mode, and the free viewpoint reproduction mode the reproduction mode of the moving image content reproduced at step S12 is.

At step S14, in a case where the reproduction processing unit 23 determines that the reproduction mode of the moving image content is the full spherical reproduction mode, the procedure shifts to step S15.

At step S15, when the operation signal indicating that the operation of changing the visual line direction is performed by the user is supplied from the operating unit 12, the operation signal obtaining unit 21 obtains the operation signal and supplies the same to the reproduction processing unit 23.

At step S16, the reproduction processing unit 23 changes the visual line direction in the moving image content reproduced in the full spherical reproduction mode according to the operation signal supplied from the operation signal obtaining unit 21 at step S15. Then, the reproduction processing unit 23 displays the moving image content to which the change in visual line direction is applied on the display unit 13.

On the other hand, in a case where the reproduction processing unit 23 determines that the reproduction mode of the moving image content is the free viewpoint reproduction mode at step S14, the procedure shifts to step S17.

At step S17, when the operation signal indicating that the operation of changing the visual line direction and the viewpoint position is performed by the user is supplied from the operating unit 12, the operation signal obtaining unit 21 obtains the operation signal and supplies the same to the reproduction processing unit 23.

At step S18, the reproduction processing unit 23 changes the visual line direction and the viewpoint position in the moving image content reproduced in the free viewpoint reproduction mode according to the operation signal supplied from the operation signal obtaining unit 21 at step S17. Then, the reproduction processing unit 23 displays the moving image content to which the change in visual line direction and viewpoint position is applied on the display unit 13.

After the process at step S16 or S18, the procedure shifts to step S19. Furthermore, also in a case where the reproduction processing unit 23 determines that the reproduction mode of the moving image content is the 2D reproduction mode at step S14, the procedure shifts to step S19.

At step S19, the reproduction processing unit 23 determines whether or not to finish reproducing the moving image content. For example, in a case where the reproduction of the moving image content is completed up to the end time, or when an operation of stopping reproducing is performed by the user, the reproduction processing unit 23 determines to finish reproducing the moving image content.

At step S19, in a case where the reproduction processing unit 23 determines not to finish reproducing the moving image content, the procedure returns to step S12, and the similar process is hereinafter repeatedly performed. On the other hand, in a case where the reproduction processing unit 23 determines to finish reproducing the moving image content, the reproducing process of the moving image content is finished.

As described above, the reproduction device 11 may allow the user to recognize the type and the reproduction mode of the moving image content by a simple user interface.

Note that, the reproduction device 11 may reproduce, in addition to the above-described 2D moving image content, full spherical moving image content, and free viewpoint moving image content, for example, each moving image content having parallax. In this case, the reproduction device 11 may display an icon (for example, a character “3D”) representing presence or absence of the parallax for each of the 2D moving image content, the full spherical moving image content, and the free viewpoint moving image content. Moreover, the reproduction device 11 may reproduce the moving image content having the parallax without parallax, and display the reproduction icon representing this.

Note that, each process described with reference to the above-described flowchart is not necessarily required to be processed in chronological order according to the order described as the flowchart, and this also includes processes executed in parallel or individually (for example, parallel processing or processing by an object). Furthermore, a program may be processed by one CPU or may be processed in a distributed manner by a plurality of CPUs.

Furthermore, a series of processes (reproducing method) described above may be executed by hardware or by software. In a case where a series of processes is executed by the software, a program which forms the software is installed from a program recording medium in which the program is recorded on a computer embedded in dedicated hardware or a general-purpose personal computer and the like, for example, capable of executing various functions with various programs installed.

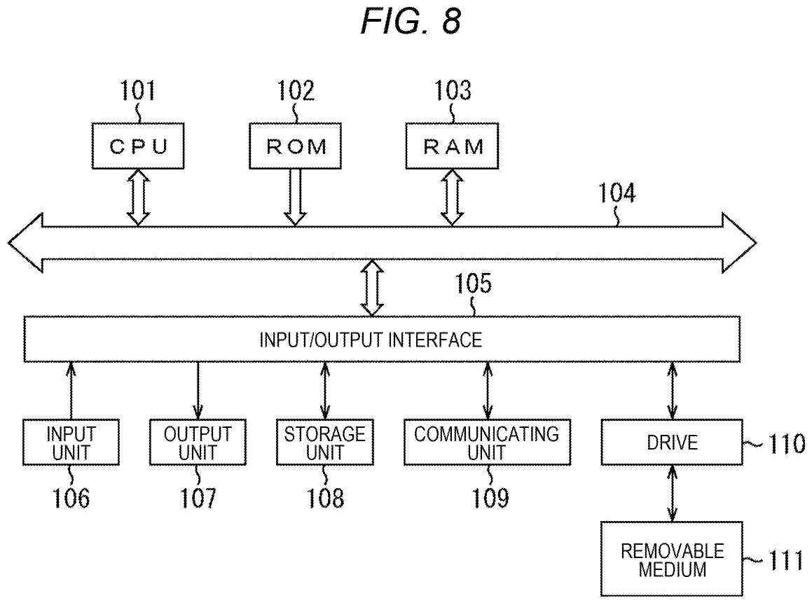

FIG. 8 is a block diagram illustrating a configuration example of the hardware of the computer which executes the above-described series of processes by the program.

In the computer, a central processing unit (CPU) 101, a read only memory (ROM) 102, and a random access memory (RAM) 103 are connected to one another by a bus 104.

An input/output interface 105 is further connected to the bus 104. An input unit 106 including a keyboard, a mouse, a microphone and the like, an output unit 107 including a display, a speaker and the like, a storage unit 108 including a hard disk, a nonvolatile memory and the like, a communicating unit 109 including a network interface and the like, and a drive 110 which drives a removable medium 111 such as a magnetic disk, an optical disk, a magnetooptical disk, and a semiconductor memory are connected to the input/output interface 105.

In the computer configured in the above-described manner, the CPU 101 loads the program stored in the storage unit 108, for example, on the RAM 103 via the input/output interface 105 and the bus 104 to execute, so that a series of processes described above is performed.

The program executed by the computer (CPU 101) is provided in a state of being recorded on the removable medium 111 which is a package medium including a magnetic disk (including a flexible disk), an optical disk (compact disc-read only memory (CD-ROM)), a digital versatile disc (DVD)) and the like), a magnetooptical disk, or a semiconductor memory, for example, or through a wired or wireless transmission medium such as a local area network, the Internet, and a digital satellite broadcasting.

Then, the program may be installed on the storage unit 108 through the input/output interface 105 by mounting the removable medium 111 on the drive 110. Furthermore, the program may be received by the communicating unit 109 via the wired or wireless transmission medium to be installed on the storage unit 108 in addition, the program may be installed in advance on the ROM 102 and the storage unit 108.

Note that, the present technology may also have following configurations.

(1)

A reproduction device provided with:

a reproduction processing unit that performs a process of reproducing a plurality of types of moving image contents in reproduction modes corresponding to the moving image contents, respectively; and

a display processing unit that performs a process of displaying a user interface displaying at least one of a type and a reproduction mode of a moving image content being reproduced.

(2)

The reproduction device according to (1) described above,

in which the display processing unit simultaneously displays the type and the reproduction mode of the moving image content.

(3)

The reproduction device according to (1) or (2) described above,

in which the display processing unit displays a reproduction time of each type for each type of the moving image contents by using a seek bar representing a reproduced portion in an entire length of the moving image content being reproduced.

(4)

The reproduction device according to (3) described above,

in which the display processing unit displays seek bars corresponding to respective types of moving image contents in parallel for each type of the moving image contents.

(5)

The reproduction device according to (4) described above,

in which the type of the moving image content to be reproduced is selected according to an operation or a user on the seek bar.

(6)

The reproduction device according to (4) or (5) described above,

in which the display processing unit grays out the seek bar corresponding to the moving image content of the type not having a function reproduced by the reproduction device.

(7)

The reproduction device according to any one of (1) to (6) described above,

in which, in a case where an operation of temporarily stopping reproduction of the moving image content is performed, the display processing unit displays a user interface displaying a temporarily stopped state for the user interface displaying the type or the reproduction mode of the moving image content.

(8)

The reproduction device according to any one of (1) to (7) described above,

in which the display processing unit displays a user interface displaying a visual line direction or a viewpoint position of a user.

(9)

A reproducing method provided With steps of:

performing a process of reproducing a plurality of types of moving image contents in reproduction modes corresponding to the moving image contents, respectively; and

performing a process of displaying a user interface displaying at least one of a type and a reproduction mode of a moving image content being reproduced.

(10)

A program that allows a computer to execute a reproducing process provided with steps of:

performing a process of reproducing a plurality of types of moving image contents in reproduction modes corresponding to the moving image contents, respectively; and

performing a process of displaying a user interface displaying at least one of a type and a reproduction mode of a moving image content being reproduced.

Note that, this embodiment is not limited to the above-described embodiment and may be variously changed without departing from the gist of the present disclosure.

### REFERENCE SIGNS LIST

11 Reproduction device
12 Operating unit
13 Display unit
21 Operation signal obtaining unit
22 Content recording unit
23 Reproduction processing unit
24 User interface display processing unit
31 Reproduced screen
41 Icon display portion
42 Seek bar display portion
43 Bar
44 Slider

1. A reproduction device comprising:
a reproduction processing unit that performs a process of reproducing a plurality of types of moving image contents in reproduction modes corresponding to the moving image contents, respectively; and
a display processing unit that performs a process of displaying a user interface displaying at least one of a type and a reproduction mode of a moving image content being reproduced.

2. The reproduction device according to claim 1,
wherein the display processing unit simultaneously displays the type and the reproduction mode of the moving image content.

3. The reproduction device according to claim 1,
wherein the display processing unit displays a reproduction time of each type for each type of the moving image contents by using a seek bar representing a reproduced portion in an entire length of the moving image content being reproduced.

4. The reproduction device according to claim 3,
wherein the display processing unit displays seek bars corresponding to respective types of moving image contents in parallel for each type of the moving image contents.

5. The reproduction device according to claim 4,
wherein the type of the moving image content to be reproduced is selected according to an operation of a user on the seek bar.

6. The reproduction device according to claim 4,
wherein the display processing unit grays out the seek bar corresponding to the moving image content of the type not having a function reproduced by the reproduction device.

7. The reproduction device according to claim 1,
wherein, in a case where an operation of temporarily stopping reproduction of the moving image content is performed, the display processing unit displays a user interface displaying a temporarily stopped state for the user interface displaying the type or the reproduction mode of the moving image content.

8. The reproduction device according to claim 1,
wherein the display processing unit displays a user interface displaying a visual line direction or a viewpoint position of a user.

9. A reproducing method comprising steps of:
performing a process of reproducing a plurality of types of moving image contents in reproduction modes corresponding to the moving image contents, respectively; and
performing a process of displaying a user interface displaying at least one of a type and a reproduction mode of a moving image content being reproduced.

10. A program that allows a computer to execute a reproducing process including steps of:
performing a process of reproducing a plurality of types of moving image contents in reproduction modes corresponding to the moving image contents, respectively; and
performing a process of displaying a user interface displaying at least one of a type and a reproduction mode of a moving image content being reproduced.
